(19) United States
(12) Patent Application Publication
(10) Pub. No.: US 2017/0173465 A1
(43) Pub. Date: Jun. 22, 2017

(54) OBJECT TRACKING INTERFACE DEVICE AS A PERIPHERAL INPUT DEVICE FOR COMPUTERS OR GAME CONSOLES

(71) Applicants: Daniel WEITZNER, Concord (CA); Peter MUELLERCHEN, Concord (CA)

(72) Inventors: Daniel WEITZNER, Concord (CA); Peter MUELLERCHEN, Concord (CA)

(73) Assignee: Visual Sports Systems Inc., Vaughan (CA)

(21) Appl. No.: 14/556,426

(22) Filed: Dec. 1, 2014

Related U.S. Application Data
(63) Continuation of application No. 13/209,046, filed on Aug. 12, 2011, now abandoned.
Application No. 13/209,046 is a continuation of application No. 11/848,956, filed on Aug. 31, 2007, now abandoned.

(51) Int. Cl. A63F 13/42; A63B 69/00; A63F 13/812; A63B 71/06; A63F 13/213; A63F 13/573; A63B 24/00; A63B 69/36

(52) U.S. Cl. CPC A63F 13/42; A63B 24/0021; A63B 69/0002; A63B 69/0026; A63B 69/3658; A63B 71/0622; A63F 13/213; A63F 13/573; A63F 13/812; A63B 2024/0034; A63B 2102/24

(57) ABSTRACT

The present invention is directed to an object tracking interface device for use as a peripheral input device with personal computers and game consoles. The object tracking interface device tracks the movement of a moving object within the field of view of the interface device and provides input to the personal computer or game console on the movement of the moving object. The object tracking interface device has one or more detection means, which view a viewed space through which the moving object moves and provide an output signal, a means for receiving the output signal of the detection means and for determining the presence of a moving object within the viewed space, a means for calculating one or more parameters of the movement of the moving object, and a means for converting the parameters of the movement of the moving object into a signal which can be input into the personal computer or gaming console.

### CROSS REFERENCE TO RELATED APPLICATIONS

This application is a continuation of U.S. Ser. No. 13/209,046 filed Aug. 12, 2011, which is a continuation of U.S. Ser. No. 11/848,956, filed Aug. 31, 2007.

### FIELD OF THE INVENTION

The present invention is directed to an object tracking interface device for use as a peripheral input device with computers and game consoles, the object tracking interface device tracks the movement of a moving object within the field of view of the object tracking interface device and provides input to the computer or game console on the movement of the moving object.

### BACKGROUND OF THE INVENTION

Video games for playing on a personal computer or game console have become quite popular. A very popular type of video game is a sports simulation game simulating a sport such as golf, hockey, football, baseball, basketball, soccer, etc. These games are generally played by the user using an interface device to interact with the video game console or computer.

A number of such user interface devices which allow a user to interact with video games and computers are known. Common examples of such interface devices include a mouse, a joystick, a keyboard, etc. These interface devices use a communication protocol to interact with the computer or game console generally through a serial communication. The most commonly utilized communication protocol is a universal serial bus (USB) created by the Universal Serial Bus Implementation Forum Inc. (USB-IF). The USB standard defines several device classes for peripherals, including the Human Interface Device (HID) class which includes keyboards, mouse, joysticks, track ball, etc., and allows the interface device to interact with the computer. Joysticks and a mouse produce output signals which are transmitted to the computer or game console to allow operation of the game. The output's signals correspond to the attitude of the joystick or mouse, which is moved along an X-Y path to control the movement of a display element on the video terminal of the computer or game console. Such interface devices as a mouse or joystick are limited to two dimensional spatial coordinates and cannot easily be used for objects moving in a three dimensional space.

A number of other types of user interface devices have been developed to allow a user to interact with video games and computers. Examples of such user interface devices include a simulated surfboard shown in U.S. Pat. No. 4,817,950, a method of playing racket and other types of games as described in U.S. Pat. No. 4,695,953 and a treadmill-type arrangement as described in U.S. Pat. No. 4,278,095. In addition, Published U.S. Patent Application No. 20070049374 by Nintendo describes a game system which utilizes a game controller having a motion detection capability. These other user interface devices have been developed to provide for a more realistic gaming experience when a user is playing games and in particular, sports simulation games. However, these user interface devices do not completely mimic the experiences the user would encounter if playing the real game particularly in a three dimensional spatial relationship.

U.S. Pat. No. 5,333,874 to Arnold describes a sports simulator in which a user can launch an object such as a golf ball toward a screen through a housing having planes defined by an array of infrared emitters and receivers positioned in the housing. A computer is connected to the infrared receivers which detect the passage of the golf ball through the planes of emitters and receivers. Based upon signals from the receivers, the computer using triangulation techniques determines the parameters of flight of the object and causes an image of the golf ball to be displayed on the screen as it would have appeared traveling away from the golfer had it not encountered the screen.

A number of systems have also been developed for monitoring the swing path of a golf club head and processing the information of the swing path of the golf club head into a predicted path of a golf ball struck by the golf club head. Examples of such systems are shown in U.S. Pat. Nos. 7,214,138; 5,471,383; 6,042,483 among others.

The use of video cameras for tracking moving objects such as golf balls, baseballs, etc is also known. Examples of such systems are shown in U.S. Pat. Nos. 5,342,051; 5,768,151; 5,938,545, among others.

U.S. Pat. No. 6,430,997 to Trazer Technologies, Inc. describes a sport simulation system which employs sensing electronics for determining the player's three-dimensional changes in a computer controlled sports specific cucing that evokes or prompts sports specific responses from the player to provide an indication of performance. The system also utilizes a virtual opponent that is responsive to and interactive with the player in real time. One type of sensing electronics mentioned is video cameras.

While the prior art describes a number of different user interfaces to more closely resemble an actual sport experience when a user is playing a sport simulation game on a dedicated computer or game console, the experience does not duplicate the experience of playing the actual game. There thus remains a need for an interface device for use with personal computers and game consoles to allow for more realistic gaming experience for the user of the game such that the gaming experience imitates to a large extent the real life experience of playing the actual game.

### SUMMARY OF THE INVENTION

The present invention is directed to an object tracking interface device for use as a peripheral input device with personal computers and game consoles. The object tracking interface device tracks the movement of a moving object within the field of view of the interface device and provides input to the personal computer or game console on the movement of the moving object. The object tracking interface device comprises one or more detection means, which view a viewed space through which the moving object moves and provide an output signal, a means for receiving the output signal of the detection means and for determining the presence of a moving object within the viewed space, a means for calculating one or more parameters of the movement of the moving object, and a means for converting the parameters of the movement of the moving object into a signal which can be input into the personal computer or gaming console.

In an aspect of the invention, the means for receiving the output of the detection means outputs a signal to the means for calculating one or more parameters of a moving object only when the presence of a moving object is detected.

In another aspect of the invention, the means for determining the presence of a moving object is a digital camera, more preferably a digital video camera.

In another aspect of the invention, the means for calculating the one or more parameters calculates the position and velocity vector of the moving object.

In another aspect of the invention, the means for calculating the one or more parameters calculates the spin of the moving object as well as the position and velocity vector of the moving object.

In another aspect of the invention, the means for converting the parameters of the movement of the moving object converts the parameters of the moving object into a signal mimicking a mouse, joystick or game controller input.

In another aspect of the invention, the means for converting the parameters of the movement of the moving object converts the parameters into a human interface device signal which is passed to the personal computer or gaming console through a universal serial bus.

In another aspect of the invention, there is provided a game apparatus for a sports simulation game for playing of sports utilizing a moving object, the game apparatus comprising a game console or personal computer containing processing means and memory, the game being loaded in the memory, a display for displaying the sports simulation game, and an object tracking interface device for tracking the movement of the moving object within the field of view of the interface device. The object tracking interface device includes an enclosure having at least one means for determining the presence of a moving object within a field of view of the object tracking interface device. The object tracking interface device also includes a means for receiving the output of the means for determining the presence of a moving object, a means for calculating one or more parameters of the movement of the moving object and a means for converting the parameters of the movement of the moving object into a signal which can be input into the personal computer or gaming console.

In an aspect of the invention, in the apparatus for a sports simulation game for playing of sports utilizing a moving object described above, the means for receiving the output of the detection means outputs a signal to the means for calculating one or more parameters of a moving object only when the presence of a moving object is detected.

In another aspect of the invention, in the apparatus for a sports simulation game for playing of sports utilizing a moving object described above, the means for determining the presence of a moving object is a digital camera more preferably a digital video camera.

In another aspect of the invention, in the apparatus for a sports simulation game for playing of sports utilizing a moving object described above, the means for converting the parameters of the movement of the moving object converts the parameters of the moving object into a signal mimicking a mouse, joystick or game controller input.

In another aspect of the invention, in the apparatus for a sport simulation game for playing of sports utilizing a moving object described above, the means for converting the parameters of the movement of the moving object converts the parameters into a human interface device signal which is passed to the personal computer or gaming console through a universal serial bus.

In another aspect of the invention, in the apparatus for a sports simulation game for playing of sports utilizing a moving object described above, the object tracking interface device is contained within an enclosure, the enclosure containing one or more video camera detection means adjacent one or more interior corners of the enclosure, the means for receiving the output data of the video camera, the means for calculating one or more parameters of the movement of the moving object based upon the output data of the video camera, the means for converting the parameter of the movement of the moving object into a human interface device signal and a universal serial bus cable for connection to the personal computer or gaming console.

### BRIEF DESCRIPTION OF THE DRAWINGS

Preferred embodiments of the present invention are illustrated in the attached drawings in which:

FIG. 1 is a perspective view of a first preferred embodiment of an apparatus of the present invention for use as a sport simulation game;

FIG. 2 is a perspective view of a further preferred embodiment of a game apparatus of the present invention.

FIG. 3 is a perspective view of a preferred embodiment of an object tracking interface device of the present invention for use in the apparatus of FIG. 1 or 2;

FIG. 4 is a perspective view of the video camera setup tracking the movement of a moving object;

FIG. 5 is a side elevation view of the video cameras tracking the motion of the moving object;

FIG. 6 is a front plan view illustrating the tracking of the position of a moving object utilizing the object tracking interface device of FIG. 3;

FIG. 7 is an illustration of the tracking of the movement of the moving object by an individual camera of the object tracking interface device of FIG. 3;

FIG. 8 is an illustration of a preferred embodiment of an interface between the video camera and a personal computer;

FIG. 9 is a block diagram of the video interface device of the present invention for use with a personal computer or game console;

FIG. 10 is a flow diagram illustrating the use of the apparatus of the present invention with an interface board to a personal computer or game console;

FIG. 11 is a flow diagram illustrating the apparatus of the present invention with a USB interface to a computer or game console; and

### DETAILED DESCRIPTION OF THE PREFERRED EMBODIMENTS

In one aspect the present invention is directed to an object tracking interface device for use as a peripheral input device with a personal computer or gaming console for playing sports simulation games. The object tracking interface device tracks the movement of a moving object within the field of view of the object tracking interface device and provides input to the personal computer or game console on the movement of the moving object. The object tracking interface device of the present invention is of particular use with sports simulation games, which utilize a ball or other moving object as part of the game.

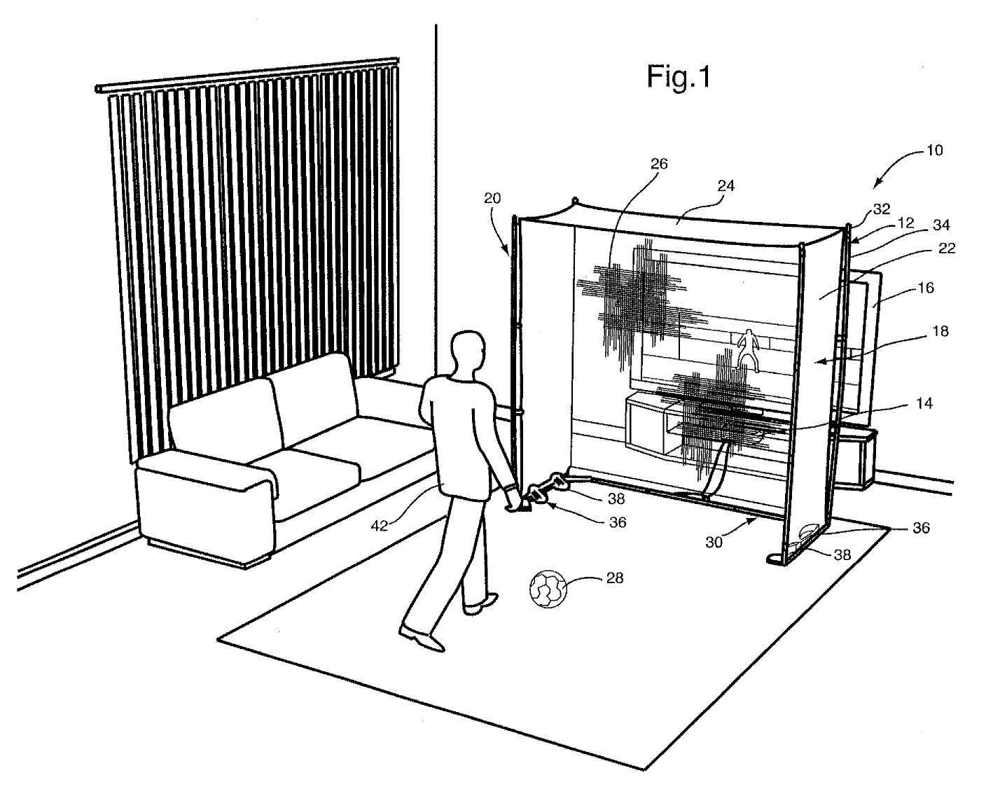

A first embodiment of a game apparatus for a sports simulation game utilizing a preferred embodiment of the object tracking interface device of the present invention and in particular an object tracking interface device utilizing digital video cameras as detection means is shown in FIG. 1 generally indicated by the numeral 10. The game apparatus 10 includes a collapsible enclosure 12 containing the object tracking interface device, a personal computer or game console 14, aid a display such as a large screen television 16.

The collapsible enclosure 12 has a fabric cover 18 and a frame 20 which is movable between an expanded position for use with the game system and a collapsed position for storage. The fabric cover 18 of the enclosure 12 has an open front, and the sidewalls 22 and top wall 24 are covered by a fabric material. The rear wall 26 is netting or mesh fabric which is selected to arrest the movement of a moving object projected into the enclosure through the open front. The sizing of the spaces or openings in the netting or mesh fabric covering the rear wall 26 is selected to ensure that any moving object does not pass through an opening of the netting or mesh fabric. For games utilizing a relatively large ball such as a soccer ball 28, the openings could be relatively large; however for games utilizing relatively smaller balls such as baseball or golf, the openings would be smaller. Preferably, to allow for the widest possible use, the fabric covering the rear wall 26 is a fine mesh material having openings small enough to allow it to be used with a golf ball.

The collapsible enclosure as illustrated in FIG. 1 utilizes a folding steel base 30 to which is attached the fabric cover 18 of one piece of the individual side panels 22 top panel 24 and rear panel 26 sewn together. The exterior corners of the fabric cover 18 are provided with loops 32 to accept one end of rods or poles 34 which form the structure of the frame 20. The rods or poles 34 are preferably metal or fiberglass shock corded rods or poles which are of a length greater than the height of the fabric cover 18 of the enclosure 12. The one end of the rods or poles 34 are provided with a hook means to engage and hold the loops 32 provided at the corners of the fabric cover 18. The other end of the rods or poles 34 are provided with a means to engage the corners of the base 30. When the rod or pole ends are hooked into the loops 32, the rod or pole 34 is bowed outwardly under tension to maintain the enclosure 12 in the expanded configuration.

The enclosure 12 of this embodiment is provided with permanently mounted object tracking interface device 36. In the embodiment illustrated in FIG. 1, the object tracking interface device 36 utilizes digital video cameras 38 mounted at the bottom corers of the base 30. A plurality of video cameras 38 capture the flight of the moving object, such as a ball 28, within the field of view of the video cameras 38. The video cameras 38 are mounted at the bottom corners of the base 30 pointing inwardly and upwardly, such that the field of view of each individual camera 38 covers the space in front of the rear wall 26. More preferably, the video cameras 38 are mounted to view into the enclosure 12 at a 45° angle. Preferably, in order to enable the video cameras 38 to more accurately track the path and velocity of the moving object such as a ball 28, more than one video camera 38 is attached at each side of the base 30, the individual video cameras 38 being spaced apart a distance to enable the timing of the path of the ball 28 to be properly tracked and calculated.

The output of the video cameras 38 is processed as will be described below and the parameters of the ball 28 such as the position, velocity vectors and spin of the ball 28, is passed to the personal computer or gaming console 14 by connecting the object tracking interface device to a USB port of the computer or gaming console 14, in place of or in addition to other peripheral input devices such as a game pad, joystick, remote or game controller.

To play a game with the sports simulation game apparatus 10 of this embodiment, the suitable game program such as the soccer game illustrated in FIG. 1, is started at the computer or game console 14. The player 42 inputs the relevant information into the game, such as a player's name and selects the game options as desired. For example, when playing a game of soccer, the player 42 will select the drill which he wishes to play, as well as other game options. The game is then started and the game information displays on the television screen 16. To commence play, the player 42 will kick the ball 28 toward the screen 16 when prompted to do so by the game. The object tracking interface detects the ball 28 movement and provides the ball flight information as an input to the computer or game console 14. From the ball flight information provided by the object tracking interface device, the game program calculates the distance and direction of the ball flight and displays the ball flight simulation on the screen 16.

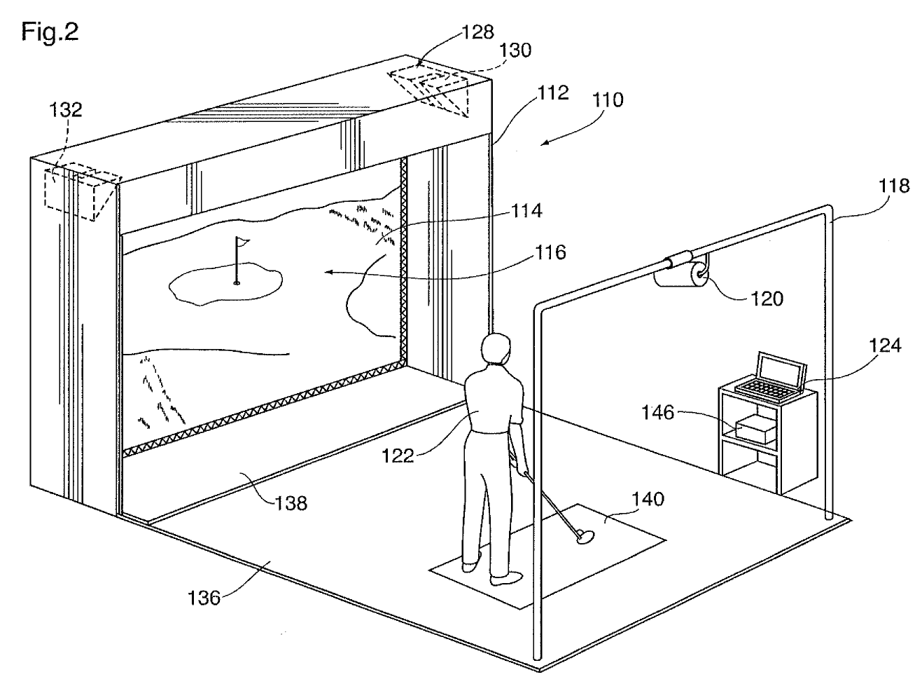

A further embodiment of a sports simulation game utilizing the object tracking interface device of the present invention and in particular an object tracking interface device utilizing digital video cameras as detection means is shown in FIG. 2. The sports simulation game playing apparatus 110 shown in FIG. 2 is for use in playing a game of golf, however as will be explained herein below, other types of games may also be played. The sports simulation game apparatus 110 may include a first frame 112, preferably constructed of tubular members joined together to form a rectangular shaped housing. A screen 114 is provided at the rear of the first frame 112 onto which may be projected the image 116 for playing the game. The screen 114 is constructed of a shock absorbing material suitable both for displaying the image as well as for stopping the moving object used in playing the game without being damaged. The apparatus 110 may also include a second frame 118 generally rectangular in shape and having mounted at the top thereof a video projector 120 such that the user 122 of the game does not interfere with the image 116 projected on the screen 114 by the projector 120. The projector 120 is connected to a personal computer or video game console 124, which contains the program for the game being played including the images 116 to be projected onto the screen 114, as well as receiving the input of the movement of the moving object 126 from the object tracking interface device 128 to allow for playing of the game.

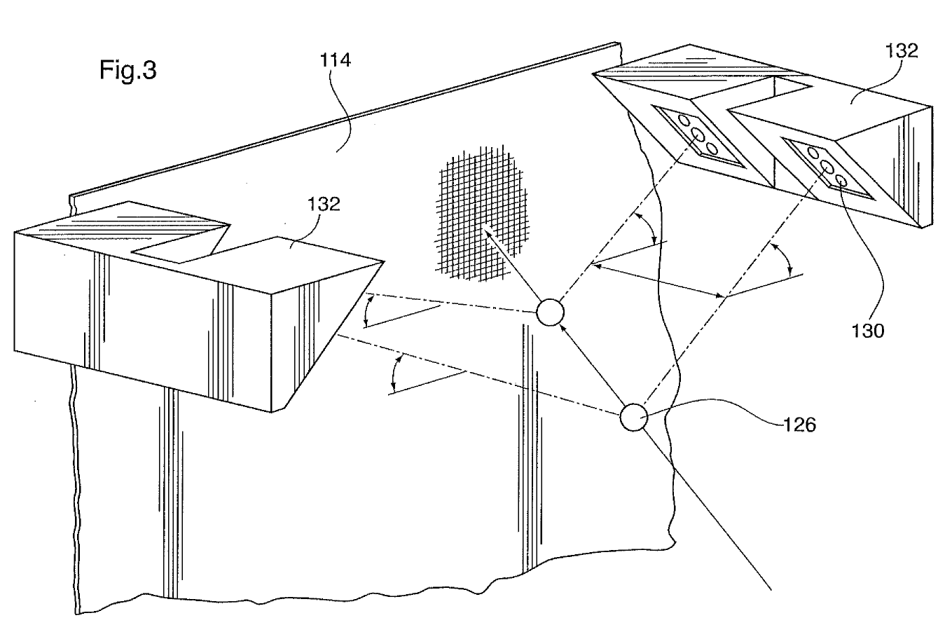

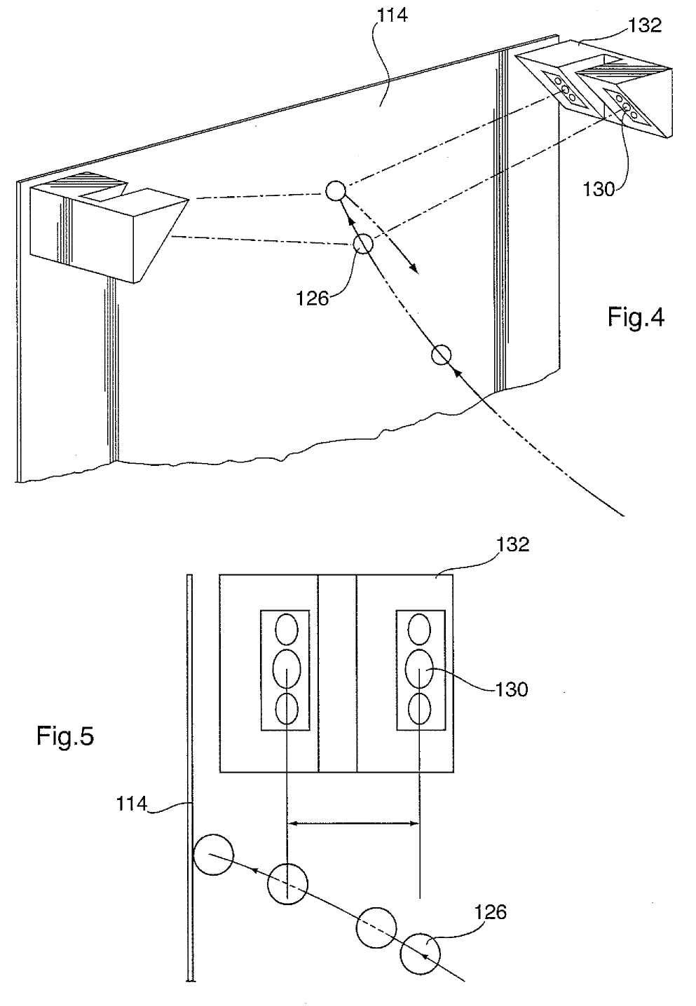

A preferred embodiment of the object tracking interface device 128 includes video cameras 130 mounted adjacent the corner of the first frame 112. As illustrated in FIGS. 3 and 4, the object tracking interface device 128 of the present invention utilizes a plurality of video cameras 130 to capture the flight of the moving object, such as a golf ball 126, within the field of view of the video cameras 130. The video cameras 130 may be mounted at the top corners of the frame 112 pointing downwardly, such that the field of view of each individual camera 130 covers area in front of the screen 114. More preferably, the video cameras 130 are mounted to view downwardly at a 45° angle. Preferably, in order to enable the video cameras 130 to more accurately track the path and velocity of the moving object such as a golf ball 126, more than one video camera 130 is attached at each side of the frame 112, the individual video cameras 130 being spaced apart a distance to enable the timing of the path of the ball 126 to be properly tracked and calculated. Alternatively, as described above with respect to the first preferred embodiment, the video cameras may be mounted adjacent the bottom corners of the frame

Each of the video cameras 130 is mounted within an enclosure 132 to be attached to the frame 112. In order to facilitate the setup and installation of the sports simulation game apparatus 110 the enclosure 132 may be adapted to hold more than one video camera 130 for mounting to each side of the frame 112. The enclosure 132 will hold the video cameras 130 utilized at each side of the frame 112 such that the enclosure 132 provides for the proper spacing and orientation of the video cameras 130 for the proper operation of the sports simulation game. Typically to allow for the proper operation of the video interface device 128 of the present invention, the cameras 130 within each enclosure 132 are spaced apart a distance of about 10 to 48 inches, preferably about 10 to 30 inches, more preferably 16 to 24 inches, most preferably about 20 inches.

The sports simulation game apparatus 110 of this embodiment includes a base 136 to which is connected the first frame 112 and second frame 118 in the proper spaced relationship to allow for operation of the game. The base 136 is provided with a mat 138 at the front thereof adjacent the screen 114, the mat 138 being of a colour to provide a proper background to allow the video cameras 130 to observe the moving object 126. Thus, for example, for playing a game of golf, the mat 138 could be black to provide a contrast for the white golf ball. For other games such as hockey where the puck is black, the mat 138 could be selected to be a lighter colour to provide for the contrast. Alternatively, the mat 138 could be a neutral colour to provide contrast with a variety of moving objects. For example, the mat 138 could be green, this providing contrast for both light and dark moving objects.

The base 136 of the sports simulation game may also be provided with a playing mat 140 that is adapted to allow for the playing of the selected game. Thus, for playing a game of golf, the playing mat 140 would be a synthetic carpet material imitating a grass mat. The playing mat 140 may be provided with tee locations to allow for teeing of the golf ball 126. By providing the playing mat 140 as a grass-like mat the player can hit the golf ball 126 directly off of the mat 140 utilizing an iron and a putter. For playing the game of hockey, the mat 140 would be a low friction plastic material to allow the user 122 to shoot the puck from the playing mat 140.

To play a game with the spurts simulation game apparatus 110 of this embodiment, the suitable game program is started at the computer or game console 124. The player 122 inputs the relevant information into the game, such as a player's name and selects the game options as desired. For example, when playing a game of golf, the player 122 will select the course which he wishes to play, as well as other game options such as handicap etc. The game is then started and the game information displays on the screen 114. To commence play, the player will hit the ball 126 toward the screen 114 when prompted to do so by the game. The object tracking interface device 128 of the present invention detects the ball 126 movement and provides the ball flight information as an input to the computer or game console 124. From the ball flight information provided by the object tracking interface device 128, the game program calculates the distance and direction of the ball flight and displays the ball flight simulation on the screen 114. The player 122 then continues to play the game by striking the ball 126 from the new position, with the desired club and the process is repeated.

The object tracking interface device of the present invention detects the parameters of the moving object in terms of velocity vector, position and spin and provides these parameters to the personal computer or game console in a format suitable for use by the game of the personal computer or game console. The object tracking interface device of the present invention includes a means for detecting and tracking a moving object, preferably tracking cameras to track the moving object and output data when a moving object is detected, a means to calculate the position, velocity vectors and spin of the moving object based upon the data received from the tracking cameras and suitable means to convert the position, velocity vectors and spin of the moving object into a format suitable for use with the personal computer or game console. Preferably, the means to calculate the position and velocity vectors and spin of the moving object based upon the data received from the tracking cameras is provided in hardware or software, more preferably in hardware on a track board.

The operation of the video camera 38 or 130 in detecting the motion of a moving object 28 or 126 will be now described with reference to FIGS. 3 to 7. As shown in the figures, the video interface device 36 or 128 of the present invention preferably includes enclosures at opposing corners of the frame. Each of the enclosures is provided with a video camera 38 or 130, the enclosure being spaced apart between 10 and 48 inches. The video cameras 38 or 130 are mounted to view at a 45° angle such that the field of view of each at the video cameras 38 or 130 covers the viewed space of the enclosure. As shown in FIG. 7, when a moving object 28 or 126 passes through the field of view of the video camera 38 or 130, an image of the object is focused by the lens 52 of the camera 38 or 130 and appears on the pickup device 54 of the video camera 38 or 130. As the object 28 or 126 moves through the field of view of the camera 38 or 130, the image of the object 28 or 126 on the pickup device 54 of the video camera 38 or 130 also moves. At regular intervals the image on the pickup device 54 on the video camera 38 or 130 is passed to a means for receiving the output of the video camera where the output is tested to see if a moving object 28 or 126 is detected by comparing successive images from the video camera. The data corresponding to the location on the video camera image 54 of the moving object 28 or 126 is transmitted to the means for calculating me or more parameters of the movement of the moving object which further processes the data to enable it to be passed through to the personal computer or game console.

The video cameras 38 or 130 are continuously monitoring the field of view, waiting for the detection of a moving object by detecting a change in the image from one frame to the next. The means for receiving the output of the video camera may accomplish this by storing the image in an image stack and comparing the two most recent entries in the image stack. As each new image is placed in the image stack, the other images are moved downwardly in the stack and the oldest image is discarded. If no change is detected between the two most recent images, the camera continues monitoring the field of view. Alternatively, a base line image for each camera may be established when the object tracking interface device starts up. This base line image is stored in a stack and the subsequent images from the cameras are compared against this base line image to detect changes in the image. When a change in image is detected, the means for receiving the output processes the images and transmits the data of the object detected to the means utilized to calculate the parameter of the moving object such as the position, velocity vectors and spin of the moving object where the data is further processed as described below.

The means to calculate the one or more parameters of the moving object utilizes triangulation of the data from the images of the video camera to calculate the parameters such as position, velocity vector and spin of the moving object. The means to calculate the parameters is provided with setup information for the object tracking interface device in terms of numbers of cameras, separation distance between the cameras and the sampling rate for the video images of the video cameras. Based upon the setup information and utilizing the data received from the video cameras, the means for calculating the one or more parameters uses a standard triangulation formula to derive the position, velocity vector and spin of the moving object. This information can then be passed through to the means to convert the data of the moving object into a format suitable for use with the personal compute or game console.

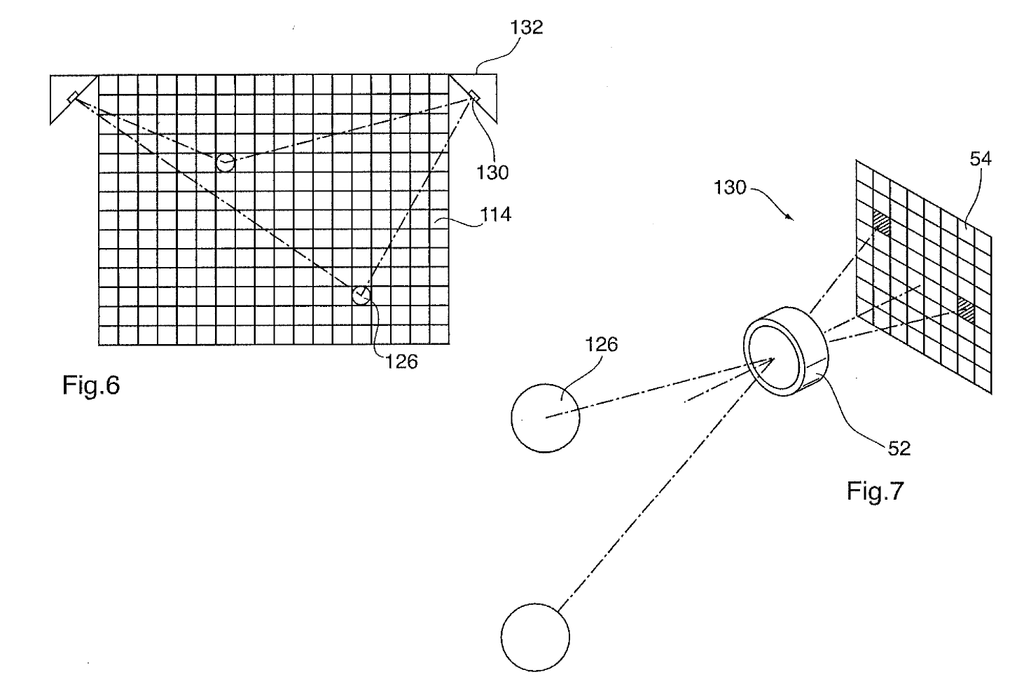

The position of the moving object 28 or 126 is determined by the means to receive the output and the means to calculate the one or more-parameters of the moving object based upon the position where the object appears on the pickup device 54 of the video camera 38 or 130. As shown in FIGS. 6 and 7, the position of the object 28 or 126 is determined by combining the position of the object displayed on the image pickup device 54 of each of the individual cameras 38 or 130 and utilizing a triangulation formula to place the moving object 28 or 126 in the three-dimensional space at the selected point and time of the sampling of the video cameras 38 or 130.

The velocity vector of the moving object in determined by comparing the position of the moving object in the three-dimensional space at predetermined time intervals. From the relative positions of the object over at least two time intervals, the velocity and direction of movement of the moving object is determined. From this data, one or more velocity vectors can then be derived.

The spin of the moving object can be determined by relating the change in position of a point on the moving object in relation to the movement of the moving object as the moving object passes through the field of view of the video camera. For example, golf balls are generally provided with a marking or logo. By determining the change in position of the marking or logo in relation to the change in position of the golf ball itself, the spin of the golf ball can be derived which is then passed through to the personal computer or game console.

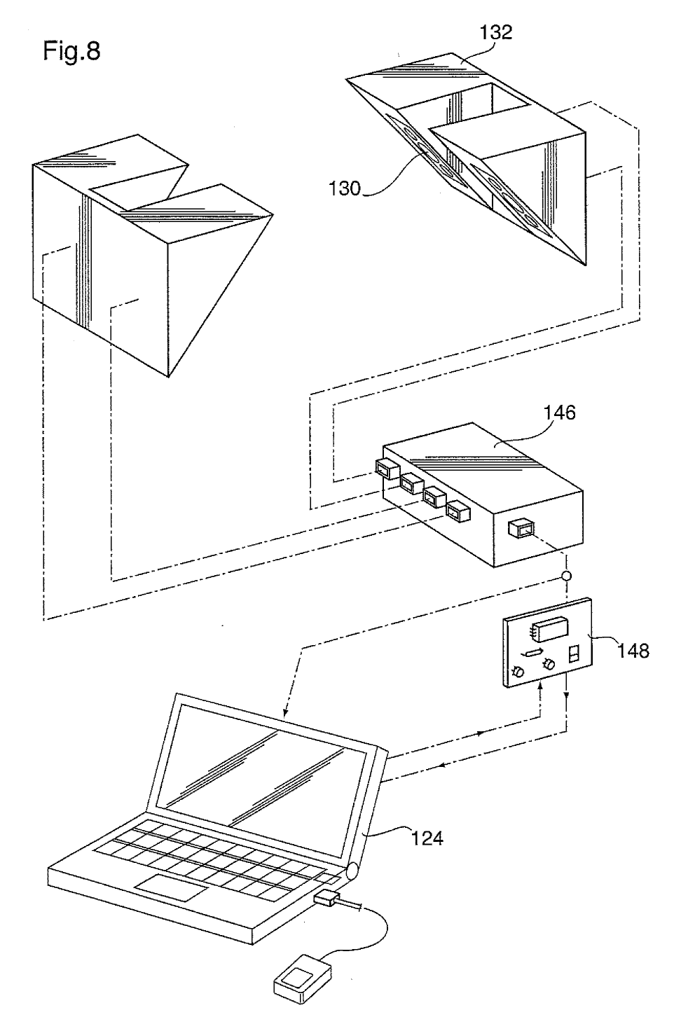

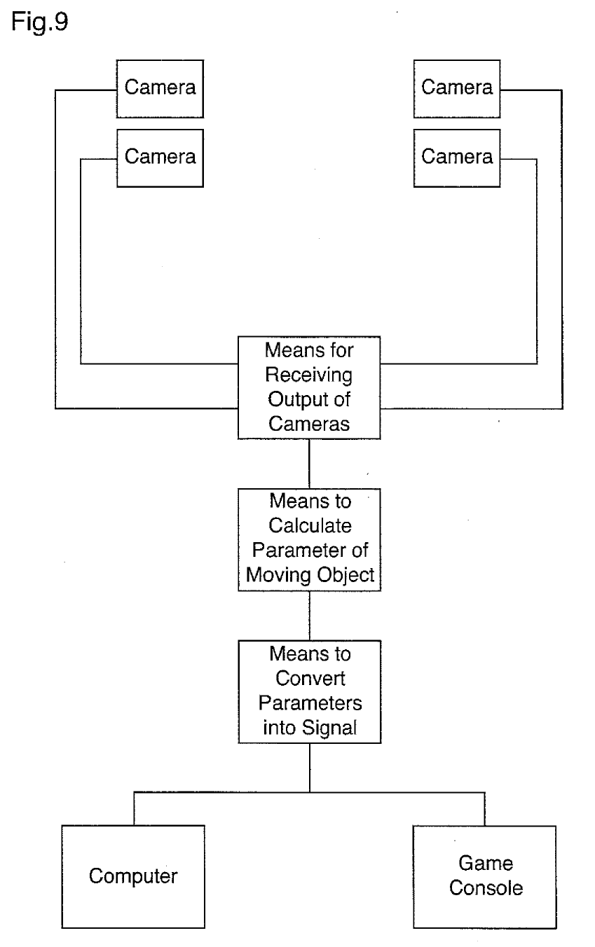

FIGS. 8 and 9 illustrate alternative embodiments of the setup of the object tracking interface device of the present invention with the computer or game console of the present invention. As described above, the object tracking interface device includes the enclosures 132 containing the video cameras 38 or 130. Each of the individual video cameras 38 or 130 plugs into an interface box 146 which contains the means to receive the output of the video camera, and the means to calculate the one or more parameters of the moving object. Preferably, the means to receive the output of the video cameras and the means to calculate the formation of the moving object are provided as a translation board 148 in hardware or software. The means to convert the data into a format suitable for use with the computer or game console is provided on a translation board 148 which can be either provided in the interface box 146 or provided as a system board for placement with the personal computer or game console. Preferrably, the means to convert the data is provided in the

interface box 146. In the one embodiment, the means to provide the information in a form suitable for use by the personal computer or game console maps the parameters of the moving object to a sequence of joystick or mouse movement utilizing the translation board 148.

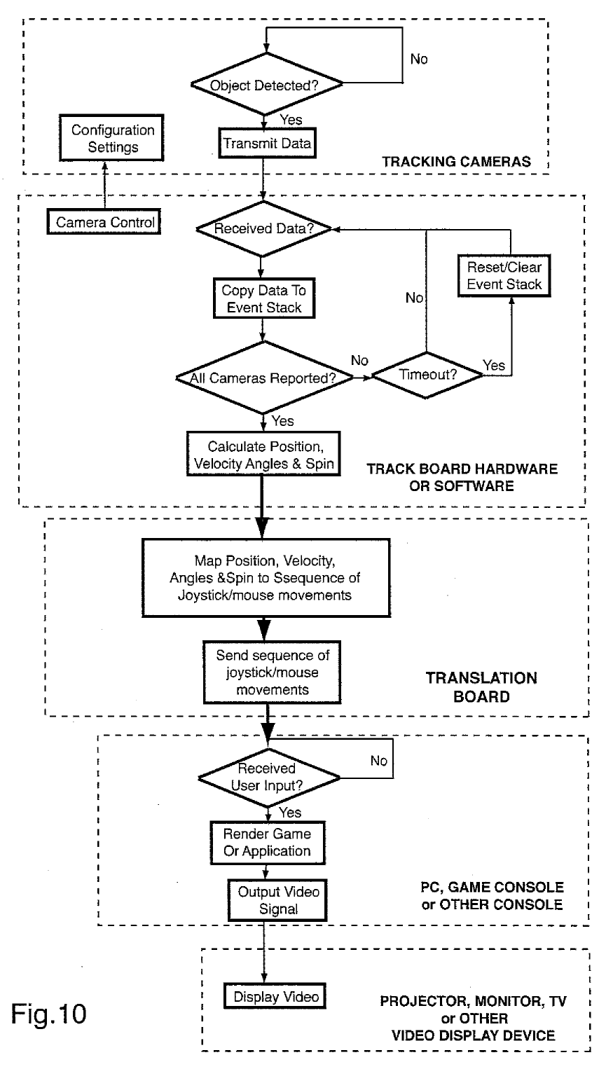

FIG. 10 illustrates a flow chart showing the operation of this embodiment of the object tracking interface device of the present invention. The tracking cameras constantly monitor the field of view and include a means to determine a change in image as a moving object comes through the field of view. If no moving object is detected, the cameras continue to monitor their field of view. Once a moving object is detected, the tracking camera transmits the data of the position of the object to the means to receive the output of the video camera and thus to the means to calculate the position, velocity vectors and spin of the moving object on the track board hardware or software. The data received from the cameras by the track board hardware or software is copied to an event stack and once all the cameras have reported, the position, velocity vectors and spin of the object are calculated. If data from one or more of the cameras is missing, the track board hardware or software checks whether there is a time out and if there is no timeout continues to wait to receive the data from the missing cameras. If the track board hardware or software has detected a timeout then it resets or clears the event stack and commences the operation again. The data of the position, velocity vectors and spin of the moving object are passed to the means to convert the position, velocity vectors and spin of the moving object into a format suitable for use with the PC or game console contained on a translation board, which maps the position, velocity vector, and spin to a sequence of game controller, joystick or mouse movements suitable for use in the game being played on the computer or game console. The translation board then sends the sequence movements to the computer or game console which utilizes the input to render the game or application producing an output video signal, which is sent to the display.

A further embodiment of the object tracking interface device of the present includes a means for encoding the parameters of the moving object into a standard format for object tracking interface devices which can be connected directly to a USB port of a personal computer or game console.

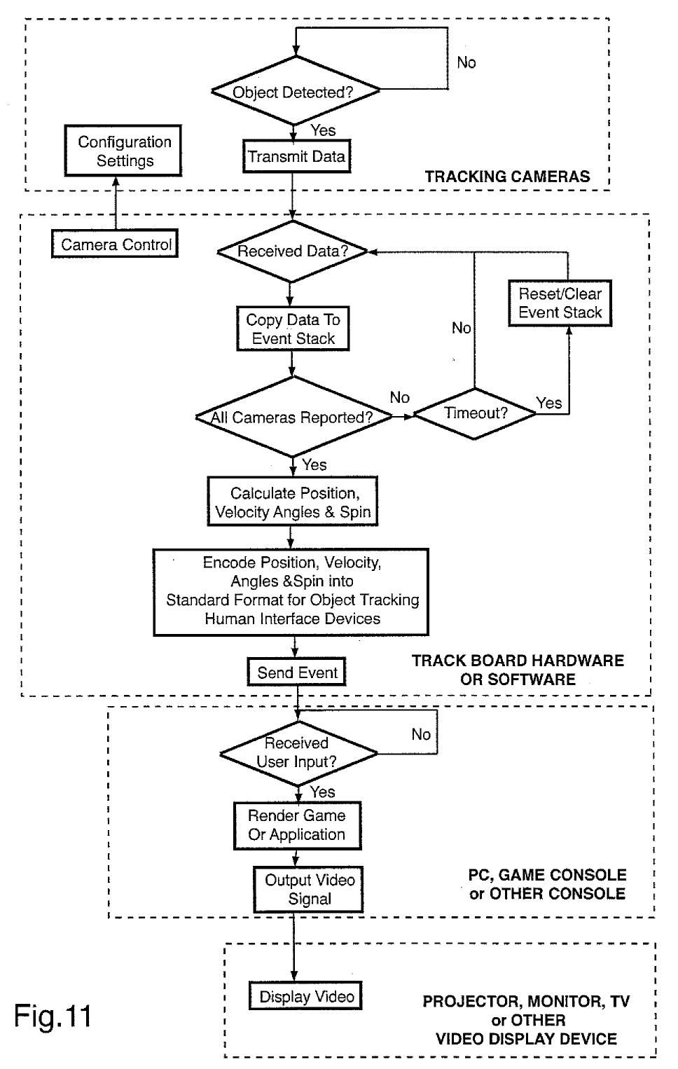

FIG. 11 illustrates a flow chart showing the operation of this further embodiment of the object tracking interface device of the present invention. This embodiment of the object tracking interface device includes a means for encoding the data of the moving object into a standard format for object tracking interface devices utilizing a USB connection. Similar to the first embodiment, the tracking cameras monitor the field of view until an object is detected. Once the moving object is detected the tracking camera transmits the data on the position of the object to the track board hardware or software. The data received from the cameras by the track board is copied to an event stack and once all the cameras have reported, the position, velocity vectors, and spin of the moving object are calculated. This calculated data is then converted by a translation board into a standard formal, which may then be passed as a standard event to a personal computer or game console utilizing an object tracking interface device protocol.

The object tracking interface device uses a universal communications protocol to become a peripheral input device for personal computers or game consoles. The current standard for communication between most electronic devices is the Universal Serial Bus (USB) created by the Universal Serial Bus Implementers Forum, Inc (USB-IF). The USB standard defines several device classes for common peripherals including the Human Interface Device (HID) class. Within the USB HID class there are usage pages defined for common HID applications, a few examples of usage pages are the simulation control, sports control, and game control pages. Each usage page further defines usage types and applications associated with it. Most operating systems have preinstalled drivers for the classes and usage pages defined by the USB-IF enabling what is commonly referred to as “plug-and-play.” Classes or usage pages that are not defined by the USB-IF generally require custom drivers. In one aspect, the present invention provides the usage types required to create an OTIID driver to utilize the full capability of the device and become plug-and-play.

One method of providing the required usage pages for the object tracking interface device of the present invention will now be described. As the object tracking interface device is a human interface device it should be a member of the USB HID class. The object tracking interface device is a device that measures the 3-Dimensional position, velocity and spin of objects. The Generic Desktop Page is the appropriate usage page for the object tracking interface device since it already contains position and velocity usage types. With a frequency usage type the Generic Desktop page would have usage types for all the parameters measured by the object tracking interface device. The following is an example of a report descriptor for an object tracking interface device.

Report Descriptor:

| USAGE_PAGE (Generic Desktop) | |
|---|---|
| USAGE (Undefined) | ;Object Tracking Interface Device |
| COLLECTION (Application) | |
| USAGE (Undefined) | ;Velocity Vector |
| COLLECTION (Physical) | |
| USAGE (Vx) | |
| USAGE (Vy) | |
| USAGE (Vz) | |
| UNIT (SI Lin:Vcl) | |
| UNIT_EXPONENT (1) | |
| LOGICAL_MINIMUM (−1024) | |
| LOGICAL_MAXIMUM (1023) | |
| PHYSICAL_MINIMUM (−1024) | |
| PHYSICAL_MAXIMUM (1023) | |
| REPORT_SIZE (11) | |
| REPORT_COUNT (3) | |
| INPUT (Data,Var,Abs) | |
| USAGE (Undefined) | |
| LOGICAL_MINIMUM (0) | |
| LOGICAL_MAXIMUM (0) | |
| REPORT_SIZE (7) | |
| REPORT_COUNT (1) | |
| INPUT (Cnst,Var,Abs) | |
| END COLLECTION | |
| USAGE (Undefined) | ;Spin Vector |
| COLLECTION (Physical) | |
| USAGE (Undefined) | ;Fx (x-axis spin) |
| USAGE (Undefined) | ;Fy (y-axis spin) |
| USAGE (Undefined) | ;Fz (z-axis spin) |
| UNIT (SI Lin:Hertz) | |
| UNIT_EXPONENT (0) | |
| LOGICAL_MINIMUM (−255) | |
| LOGICAL_MAXIMUM (255) | |
| PHYSICAL_MINIMUM (−255) | |
| PHYSICAL_MAXIMUM (255) | |
| REPORT_SIZE (9) | |
| REPORT_COUNT (3) | |
| INPUT (Data,Var,Abs) | |
| USAGE (Undefined) | |
| LOGICAL_MINIMUM (0) | |
| LOGICAL_MAXIMUM (0) | |
| REPORT_SIZE (5) | |
| REPORT_COUNT (1) | |
| INPUT (Cnst,Var,Abs) | |
| END_COLLECTION | |
| USAGE (Undefined) | ;Position (plane 1) |
| UNIT (SI Lin:Distance) | |
| UNIT_EXPONENT (−1) | |
| LOGICAL_MINIMUM (−32767) | |
| LOGICAL_MAXIMUM (32767) | |
| PHYSICAL_MINIMUM (−32767) | |
| PHYSICAL_MAXIMUM (32767) | |
| COLLECTION (Physical) | |
| USAGE (X) | |
| USAGE (Y) | |
| USAGE (Z) | |
| REPORT_SIZE (16) | |
| REPORT_COUNT (3) | |
| INPUT (Data,Var,Abs) | |
| END_COLLECTION | |
| USAGE (Undefined) | ;Position (plane 2) |
| COLLECTION (Physical) | |
| USAGE (X) | |
| USAGE (Y) | |
| USAGE (Z) | |
| REPORT_SIZE (16) | |
| REPORT_COUNT (3) | |
| INPUT (Data,Var,Abs) | |
| END_COLLECTION | |
| USAGE (Undefined) | ;Position (screen) |
| COLLECTION (Physical) | |
| USAGE (X) | |
| USAGE (Y) | |
| USAGE (Z) | |
| REPORT SIZE (16) | |
| REPORT COUNT (3) | |
| INPUT (Data,Var,Abs) | |
| END_COLLECTION | |
| USAGE (Pointer) | ; optional (screen) |
| COLLECTION (Physical) | |
| USAGE (X) | |
| USAGE (Y) | |
| LOGICAL_MINIMUM (−128) | |
| LOGICAL_MAXIMUM (127) | |
| REPORT_SIZE (8) | |
| REPORT_COUNT (2) | |
| INPUT (Data,Var,Abs) | |
| END_COLLECTION | ;end of optional pointing device |
| END_COLLECTION | |

The USB HID class requires report descriptors for the operating system to determine the device configuration. Table 1.1 summarizes the report descriptor.

TABLE 1.1
Summary of report descriptor

Bit

| | | | | | | | | |
|---|---|---|---|---|---|---|---|---|
| Byte | 7 | 6 | 5 | 4 | 3 | 2 | 1 | 0 |

| | |
|---|---|
| 0 | Vx (decimeters/second) |

| | | |
|---|---|---|
| 1 | Vy (decimeters/second) | Vx |

| | | |
|---|---|---|
| 2 | Vz | Vy |

| | |
|---|---|
| 3 | Vz (decimeters/second) |

| | | |
|---|---|---|
| 4 | Constant | Vz |

| | |
|---|---|
| 5 | Fx (Hertz) |

| | | |
|---|---|---|
| 6 | Fy (Hertz) | Fx |

| | | |
|---|---|---|
| 7 | Fz (Hertz) | Fy |

| | | |
|---|---|---|
| 8 | Constant | Fz |

| | |
|---|---|
| 9 | Position - Plane1 X (mm) |
| 10 | |
| 11 | Position - Plane1 Y (mm) |
| 12 | |
| 13 | Position - Plane1 Z (mm) |
| 14 | |
| 15 | Position - Plane2 X (mm) |
| 16 | |
| 17 | Position - Plane2 Y (mm) |
| 18 | |
| 19 | Position - Plane2 Z (mm) |
| 20 | |
| 21 | Position - Screen X (mm) |
| 22 | |
| 23 | Position - Screen Y (mm) |
| 24 | |
| 25 | Position - Screen Z (mm) |
| 26 | |
| 27 | X (optional pointer) |
| 28 | Y (optional pointer) |

There are several “USAGE (Undefined)” entries in the report descriptor. In order to not require a custom driver and to provide play and play support, these sections will be defined in the USB standard for plug-and-play compatibility. In the output description, suggested definitions for the USB standard are provided in the comment beside each instance. There is also an optional section in the report descriptor defining a pointing device allowing the object tracking interface device to act as a touch screen.

The report descriptor displays the general functionality of an object tracking interface device. Sections of the report required for configuration of a specific implementation of an object tracking interface device have been condensed and summarized. The full definition of the HID class and usage tables can be found at http://www.usb.org/developers/devclass_docs/IIut1_2.pdf and http://www.usb.org/devlopers/devclass_docs/HID 1_11.pdf.

The object tracking interface device of the present invention allows for tracking of moving objects within the field of view of the device so that the parameters of the moving object such as the position, velocity vectors end spin of the moving object, can be passed to a personal computer or gaming console in a format suitable for use by the computer or gaming console. This object tracking interface device of the present invention is of particular use for playing sports simulation games, which include a moving object, such as a ball as part of the game. For example, the object tracking interface device of the present invention can be utilized for playing a golf simulation game, where the moving object is a golf ball struck by the player of the game. By utilizing the object tracking interface device the present invention the player can play a number of sports simulation games presently available for personal computers and game consoles in a more realistic manner. Many of these sports simulation games utilize mouse or joystick motions to imitate the action of striking of the ball. By utilizing the object tracking interface device of the present invention as a peripheral input device, the player of the game can actually participate in the game by replacing the unrealistic joystick or mouse control with the actual striking of the ball. In this manner not only is the player playing a game in a more realistic manner but the feedback provided by the game also allows for improvement of the player's skills required for playing the game.

In addition to the games of golf and soccer, illustrated in the figures, the object tracking interface device of the present invention may also be used for other games, which include a moving object. For example, in baseball games, rather than using the joystick or mouse for deciding upon the type of pitch to be thrown by a pitcher, the player of the game can actually pitch the hall to the representation of a batter displayed on the screen. In this way, the operation of game is more realistic and it also allows for immediate feedback for skill development of the player. Similarly, a hockey game could be played utilizing the object tracking interface device of the present invention where the player would shoot the puck at a goalie, rather than merely utilizing the joystick or other game controller. The use of the object tracking interface device of the present invention with other game types will be apparent to those of skill in the art.

An object tracking interface device of the present invention has been described utilizing cameras, in particular digital video cameras as the detection mean for tracking of moving objects within the field of view of the video camera. It will be appreciated by those of skill in the art that other detection means for determining the presence of a moving object may also be utilized within the object tracking interface device of the present invention so long as the detection means outputs data that indicates the position of the object within a three dimensional space at a particular point in time. In this way, the data from the detection means can be utilized by the means for receiving the output of the detection means for determining the presence of a moving object and the means to calculate one or more parameters of the movement of the moving object and converting those parameters into a signal which can be input into the computer or gaming console. For example, other types of detection means which may be utilized to track moving objects for the object tracking interface device of the present invention include radar, infrared detectors and emitters and other sensor arrays, etc. Preferably the detection means to determine the presence of the moving object for use in the object tracking interface system of the present invention is digital cameras and more preferably the digital video cameras as described above. The use of the digital video cameras as described above provides for a versatile, highly configurable, inexpensive solution for tracking and determining the motion of the moving object in a three dimensional space as well as for simulation of the continued movement of the object beyond the monitored space.

The object tracking interface device of the present invention particularly provides for more realistic gaming experience for player of sports simulation games. The object tracking interface device of the present invention provides numerous advantages over the prior art setups, particularly for playing of sports simulation games. The current user interface utilized in such games provides information on two dimensional coordinates using a mouse or joystick or an angular motion, for example, utilizing a wheel. The object tracking interface device of the present invention provides sets of three dimensional coordinates of objects, velocity vectors of the objects, size of the objects, etc. to enable realistic simulation of the motion and action of the object in a sports simulation game. In some situations, the extensive image processing required by the prior art systems slow the game operation and could interface with the gaming experience. A number of current peripheral devices available require extensive image processing and therefore the results with such devices vary from game to game. The object tracking interface device of the present invention provides for preprocessed, standardized info which does not require extensive image processing by the personal computer or game console and thus saves the personal computer or game console processing capabilities resulting in a more realistic gaming experience. The object tracking interface device of the present invention is usable with many existing sports simulation games as the object tracking interface device can provide input to the game in the format recognized by the game through the conversion of the data on the moving object into a format recognized by the game. In addition, through the use of the OTHID, further capabilities of the object tracking interface device of the present invention can be employed to enhance the player's gaming experience.

The object tracking interface device of the present invention if also usable as a general peripheral device with other applications other than sports simulation games. As the object tracking interface device tracks the motion of a moving object, the object tracking interface device could also be utilized with other applications relating to movement of moving objects. For example, a user could move parts of their body within the monitoring field of view of the video camera and utilize the object tracking interface device of the present invention for practicing activities which require movement such as dance, martial arts, etc. Similarly, the user could use the detected motion to draw images or the display screen e.g. finger painting. Other uses of the object tracking interface device of the present invention will be apparent to those of skill in the art.

Although various preferred embodiments of the present invention have been described herein in detail, it will be appreciated by those of skill in the art that variations may be made thereto without departing from the spirit of the invention or the scope of the appended claims.

We claim:

1. An object tracking interface device for use as a peripheral input device with personal computers or game consoles for tracking the movement of a moving object utilized in a sports simulation game within the field of view of the object tracking interface device and providing input to the computer or game console on the movement of the moving object, the object tracking interface device comprising one or more detection means which view a viewed space through which the moving object moves, the detection means being provided at the corners of the viewed space, a means for receiving the output of the detecting means for determining the presence of the moving object, a means for calculating the position and velocity vector of the moving object from the output of the detecting means and a means for converting the position and velocity vector of the moving object into a human interface device signal which is passed to the computer or game console as a signal from the peripheral input device through a universal serial bus, the object tracking interface device allowing for the use with any sports game utilizing simulation games including a moving object.

2. An object tracking interface device according to claim 1 wherein, the means for calculating the position and velocity vector of the moving object also calculate the spin of the moving object.

3. An object tracking interface device according to claim 2 wherein, the means for converting the position, velocity vector and spin of the moving object converts the position, velocity vector and spin of the moving object into a signal mimicking a mouse, joystick or game controller input.

4. An object tracking interface device according to claim 1 wherein, the detection means is a digital camera.

5. An object tracking interface device according to claim 2 wherein, the detection means is a digital camera.

6. An object tracking interface device according to claim 3 wherein, the detection means is a digital camera.

7. A game apparatus for any of a plurality of sports simulation games far playing of a sports simulation games utilizing a moving object, the apparatus comprising a game console or personal computer containing processing means and memory, the game being loaded in the memory, a display for displaying the sports simulation game, and an object tracking interface device according to claim 1 connected to the computer or a game console through a universal serial bus.

8. A game apparatus for any of a plurality of sports simulation games for playing of a sports simulation games utilizing a moving object, the apparatus comprising a game console or personal computer containing processing means and memory, the game being loaded in the memory, a display for displaying the sports simulation game, and an object tracking interface device according to claim 6 connected to the computer or a game console through a universal serial bus.

9. An apparatus according to claim 7 wherein the collapsible enclosure comprises a fabric cover and a frame which is movable between a collapsed position whereby the enclosure may be easily stored and an expanded position for playing a game, the fabric cover of the enclosure in the expanded position having an open front, side and top walls and a rear wall, the rear wall being a material which is selected to arrest the movement of the moving object projected into the enclosure through the open front, while permitting a user to observe an image displayed on the rear wall of the enclosure.

10. An apparatus according to claim 8 wherein the collapsible enclosure comprises a fabric cover and a frame which is movable between a collapsed position whereby the enclosure may be easily stored and an expanded position for playing a game, the fabric cover of the enclosure in the expanded position having an open front, side and top walls and a rear wall, the rear wall being a material which is selected to arrest the movement of the moving object projected into the enclosure through the open front, while permitting a user to observe an image displayed on the rear wall of the enclosure.
